(19) United States
(12) Patent Application Publication
(10) Pub. No.: US 2009/0148580 A1
(43) Pub. Date: Jun. 11, 2009

(54) Use of natural agave extract as a natural sweetener replacing other added sweeteners in food products and medicines

(76) Inventors: Juan A. Heyer, Guadalajara (MX); James Ray Crawford, San Diego, CA (US)

Correspondence Address: James Ray Crawford, 3654 Boundary Street, San Diego, CA, 92154, US

(21) Appl. No.: 11/999,719

(22) Filed: Dec. 6, 2007

(51) Int. Cl. A23L 1/236

(52) U.S. Cl. 426/548

(57) ABSTRACT

This invention is about using natural AGAVE extract as a sweetener, to replace all or part of the high-calorie sugars and or artificial sweeteners added in foods and medicines promoting an important reduction of calories and the elimination of artificial sweeteners by using natural AGAVE extract as the main sweetening ingredient.

### REFERENCES CITED

US patent Documents

| | | |
|---|---|---|
| 7186431 | Mar. 06, 2007 | Silver |
| 7169431 | Jan. 30, 2007 | Lasdon |
| 7138154 | Nov. 21, 2006 | Brendel et al |
| 6623783 | Sep. 23, 2003 | Wong |
| 6783789 | Aug. 31, 2004 | Mutilangi et al |
| 6423358 | Jul. 23, 2002 | Barndt et al |
| 5840361 | Nov. 24, 1998 | Thever et al |
| 5846333 | Dec. 08, 1998 | Partida et al |
| 5254174 | Oct. 19, 1993 | Hansen |
| 20070224323 (Application) | Sep. 27, 2007 | Goldman |
| 20070269569 (Application) | Nov. 22, 2007 | Bashor |
| 20070042992 (Application) | Feb. 22, 2007 | Frippiat |

### BACKGROUND

1. Field of Invention

This invention is about using natural AGAVE extract as a natural sweetener to replace all or part of the high-calorie sugars and or artificial sweeteners added in foods and medicines promoting an important reduction of calories and the elimination of artificial sweeteners by using natural AGAVE as the main sweetener ingredient.

Agave sweetener is obtained from the AGAVE PLANT grown in arid regions, by extracting the Agave juice from it and processing it into a syrup. (REFERENCE: U.S. Pat. No. 5,846,333 Dec. 08 1998 Partida et al).

Commercially, other names for Agave sweetener have been “Nectar” or “Syrup” as well as other similar descriptive or extension names, however it is generally considered a SYRUP like product which can be processed as Organic, Natural or Raw. It can be light to dark in color, thicker or thinner in consistency, and even made into powder or crystals if dehydrated totally.

2. Prior Art

Traditional sweeteners like cane sugar (sucrose), corn syrup, high fructose, etc. used in food products and medicines, have become excessive in the daily diets of the general public, causing various health problems along with obesity, diabetes and poor eating habits, etc.

Due to the high amount of carbohydrate intake, one third of the US population already has obesity problems. Diabetes, arthritis, colon, heart problems and many other diseases are directly related to excessive intake of carbohydrates, most of them added to food products and medicines in the form of glucose, corn syrup, cane sugar, high fructose and starches. Artificial sweeteners were invented to lower calories with the idea of solving those problems related to high calorie intake. With time other health problems arouse, not related to obesity, but with a new series of health problems, caused by the chemical substances found in most of these artificial sweeteners.

Saccharine, phenylalanine, Aspartame, among others, have already been found to be harmful to human health in different levels. Some have been proven to be carcinogenic, while others cause the production methyl alcohol in the body (which is poisonous to humans), and have found to be related to illnesses such as liver and or kidney malfunction, as well as arthritis and brain damage.

Natural Agave used as a replacement sweetener can greatly reduce these problems. It substantially lowers calorie intake, it also promotes the growth of intestinal flora in the gut, thus improving digestion and most importantly promoting a healthier colon. Natural Agave is becoming recognized as a healthy alternative to using Carbon based sugars and synthetic sweeteners.

New and updated research declares natural Agave to be SAFE, HEALTHY, and very low in calorie absorption, likewise because of it's very low Glycemic Index, it is also safe for diabetics. We see many Dieticians, Doctors, Health Clinics recognizing the advantages and health benefits from natural Agave sweetener.

### Agave Advantages:

There is a substantial advantage in using AGAVE sweetener instead of other traditional and artificial sweeteners. AGAVE used as a natural sweetener has the following unique advantages:
1. AGAVE is very beneficial as a Low Calorie Sweetener, since 95% of the sugars in AGAVE are not absorbed by the body and do not enter into the blood stream.
2. Traditional sweeteners increase blood sugar levels while AGAVE does not.
3. The absorption of the AGAVE sugars is only 5%, while the absorption of glucose or regular sugar is 95%, making AGAVE sweetener safe, especially for dieters, diabetics and for the publics general health. Agave used as a natural sweetener has NO adverse effects on children.
4. The inulin content of AGAVE sweetener promotes the growth of intestinal flora, therefore improving digestion.
5. It does not contain harmful substances, like phenylalanine, (aspartame) or other related chemicals which are generally rated as hazardous to human health.
6. AGAVE sweetener has a LOW GLYCEMIC INDEX Certification by the Glycemic Research Institute in Washington D.C., which ran extensive tests on AGAVE for several months and have concluded that AGAVE is Diabetic Friendly.
7. Natural AGAVE sweetener is rich in vitamin B, C, D, E, calcium, iron, phosphorus, magnesium, potassium, zinc, selenium, chromium and especially inulin.
8. One of AGAVE sweetener's main advantage is it's INULIN content. Because normal digestion does not breakdown the Agave sugars into monosaccharides, and it does not elevate blood sugar levels, therefore it becomes helpful in the management of diabetes. Inulin also stimulates the growth of bacteria in the gut. Inulin passes through the stomach and duo-denum undigested and is highly available to the gut, (colon) bacterial flora.
9. Medicinally, AGAVE has been used as a blood purifier, to improve digestion, and as an anti-inflammatory.
Patent Application #20070224323 (Goldman) Teaches a sugar replacement comprising: Agave inulin, and Agave fructose. Goldman is extracting components from Agave and further blending artificial sweeteners. Whereas our invention is using the whole Natural Agave juice accomplished by removing only water therefore maintaining all it's nutritional components and positive health benefits.

### DETAILED DESCRIPTION

Traditional natural and artificial sweeteners are added to most food products and medicines. These sweeteners can range from 2% to 98% of their total content.

Our invention is about using natural AGAVE as a healthier alternative SWEETENER wherever natural sugars or chemically produced artificial sweeteners are used.

Therefore our invention can cover a very wide spectrum of sweetener based food products and medicines. Of course, it is the intent of our invention to replace as much of these Natural and Artificial, potentially harmful sweeteners as possible, with Natural AGAVE sweeteners, offering healthier alternatives to the general public.

According to our invention natural AGAVE can be used as the MAIN SWEETENER in most Foods and Medicines, to include, but not limited to the following products:
1. Pancake, Waffle, French Toast syrups.
2. Jams, Jelly, Marmalade, Preserves and similar products.
3. Canned, Bottled and/or Dried Fruit products like: Peaches, Pears, Apples, Pineapple, etc.
4. Confection syrups as used in Ice Milks, Ice Creams, Desserts, Dairy and Non-Dairy products.
5. Soft and Hard drinks, fountain drink syrups, freezee/slushy and blended type products.
6. Fruit Juices and Fruit Drinks.
7. Coffee, Tea and hot drink sweetener.
8. Coffee flavoring syrups and confection type flavorings.
9. Nut butters.
10. Medicine, Pharmaceutical and Medicines as well as other health food products.
11. Candy, Confections and Frostings related products.
12. Baby Foods, and other foods with sugars and/or artificial sweeteners added.

### EXAMPLE OF USE

Most Pancake Syrup formulas include sweeteners like Corn Syrup, high fructose, with as much as 95% of the total weight of the product. According to our invention, the sweeteners used are partially or totally replaced by Agave syrup proportionally. So, the improved formula would typically be:
1. Flavoring concentrates, (1 to 20%)
2. Stabilizers, thickeners, preservatives and colorants (minimal percentage, if any),
3. Agave syrup as a sweetener (20 to 98%).

Natural Agave is 20% sweeter than sugar, otherwise portions remain nearly the same.

### EXAMPLE 2

For the preparing of Ice Cream formulas, the same ingredients would be typically used replacing partially or totally the high fructose, sucrose, corn syrup or aspartame, with Agave syrup, powder or crystals to meet the desired sweetness.

### EXAMPLE 3

For the preparing of Light or Low calorie soft drink formulas the same ingredients typically used, replacing, partially or totally, artificial sweeteners with an amount of Agave sweetener necessary to meet the desired sweetness.

### EXAMPLE 4

Any food product or medicine claiming to be a Low Calorie product that uses any kind of sweetener, said sweetener can be replaced by Agave sweetener, and still stand as a LIGHT or LOW calorie item. With the advantage of the producer being able to eliminate the “CAUTION” sign on the label, and replace it with the “DIABETIC FRIENDLY” words.

### Conclusion:

The addition of thickeners, pectin's, xantan gum or any other additives, coloring or flavoring, (natural or artificial) are, to one skilled in the art, considered as falling within the scope, or the spirit of this invention.

While the above description contains many specificities, there should not be construed as limitations on the scope of any embodiments, exemplifications of the presently preferred embodiments there of many other ramifications and variations are possible within the teachings of various embodiments. Thus the scope of the invention should be determined by appended claim and their legal equivalent, and not by the examples given.

We claim:

1. The use of Natural AGAVE extract as a sweetener to partially or totally replace sugars and artificial sweeteners added to foods and medicines.

2. The use of Natural AGAVE extract according to claim 1.added to foods and medicines in the form of Syrup.

3. The use of Natural AGAVE extract according to claim 1.added to foods and medicines in the form of powder.

4. The use of Natural AGAVE extract according to claim 1.added to foods and medicines in the form of crystals.

5. The use of Natural AGAVE extract according to claim 1.added to foods and medicines in the form of liquids.

6. The use of Natural AGAVE extract according to claim 1.added to foods and medicines in the form of granules.

7. The use of Natural AGAVE extract according to claim 1.added to foods and medicines in the form of dehydrated matter.

8. The use of Natural AGAVE extract as a sweetener in candies in its many forms.

9. The use of Natural AGAVE extract as a sweetener in baking in its many forms.
